(19) United States
(12) Patent Application Publication
(10) Pub. No.: US 2017/0061409 A1
(43) Pub. Date: Mar. 2, 2017

(54) CROSS-CHANNEL SYSTEM FOR ELECTRONIC COMMERCE AND METHODS USEFUL IN CONJUNCTION THEREWITH

(71) Applicant: ZOOZ MOBILE LTD., Kfar Saba (IL)

(72) Inventors: Ronen MORECKI, Kfar Saba (IL); Oren LEVY, Raanana (IL)

(73) Assignee: ZOOZ MOBILE LTD., Kfar Saba (IL)

(21) Appl. No.: 15/120,176

(22) PCT Filed: Feb. 25, 2015
(86) PCT No.: PCT/IL2015/050209

§ 371 Date: Aug. 19, 2016

Related U.S. Application Data
(60) Provisional application No. 61/944,270, filed on Feb. 25, 2014.

(51) Int. Cl. G06Q 20/12; G06Q 20/42; G06Q 20/38

(52) U.S. Cl. CPC G06Q 20/12; G06Q 20/3829; G06Q 20/42; G06Q 2220/00

(57) ABSTRACT

A method for recognizing end-users communicating with a computerized entity serving end-users via a plurality of entity/end-user communication channels, method comprising capturing personal particulars for each user from among a multiplicity of end-users via a first channel and storing the personal particulars in a corresponding multiplicity of end-user records in an end-user database, thereby to define a first, data capturing session for each of the multiplicity of end-users; and accessing at least one individual end-user's record during a second, data recognizing session, held via a second channel between the individual end-user and computerized entity subsequent to the first data capturing session therebetween, accessing including recognizing end-user by identifying the end-user record from among the multiplicity of end-user records which corresponds to the end user; and performing at least one of reading from and writing to the end-user record, wherein the channels comprise one physical channel and one online channel.

### REFERENCE TO CO-PENDING APPLICATIONS

Priority is claimed from U.S. Provisional Patent Application No. 61/944,270 entitled “System for unified cross-channel payment and method of use” and filed Feb. 25, 2014.

### FIELD OF THIS DISCLOSURE

The present invention relates generally to transactions between computerized entities and more particularly to transactions between remote computerized entities.

### BACKGROUND FOR THIS DISCLOSURE

Conventional technology constituting background to certain embodiments of the present invention is described in the following publications inter alia:

Published PCT Patent Application WO 2014151507, filed 13 Mar. 2014, speaks of the problem of how “to identify a user over disparate communications channels. For example, it is difficult to determine that a person on a mobile device is the same person that is online” and notes that the prior art has not succeeded in solving the problem: “Prior art algorithms typically provide guesses as to the identity of users. That is, prior art algorithms reduce the identity down to a few likely candidates that may be the same, but do not provide a one-to-one solution.” The WO 2014151507 application, describes “omni-channel identity matching” in which “identifiers from online and offline communication channels are obtained. A user that corresponds to at least one of the identifiers is identified. An identity profile is created for the user that contains the at least one of the identifiers corresponding to the user. The identity profile is maintained in an identity profile store. A communication, such as an ad request, containing an identifier is received. The identity profile that matches the identifier received in the communication is determined. In some embodiments, an advertisement may be determined to be returned to the user based on the identity of the user.”

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Retailers are struggling to maintain the same experience between their physical in-store point-of-sale experience to their online eCommerce/mCommerce experience. There is a need to unify different channels of shopping so as to provide buyers and retailers a seamless shopping experience. By unifying all shopping channels, retailers are able to provide a consistent personalized experience, increasing consumer conversions, loyalty and retention rates. Retailers are looking for ways to eliminate this gap between the physical and online world, the ideal being that both worlds will maintain the same personalized approach and recognize consumers across all channels. Thus, a drastic change to the current state of the art, where a retailer is obliged to maintain two sets of customer presence, the online customer and the offline customer, is sought.

Certain embodiments seek to provide a system configured and operable to allow unified cross channel recognition and payment and methods of using the system.

Certain embodiments seek to provide a method and system configured to enable retailers to provide one unified payment experience across all channels of shopping, which involves creating a single customer presence in both the online and physical world.

According to certain embodiments, the system facilitates acceptance by retailers of every type of payment method (including eWallets). Customers only have to pay one time with their chosen payment method, be it in-store, on their smartphone, or from their desktop or any other device connected to the Internet (Smart TVs, Mobile Phones, Tablets, etc). This data is then stored for all future purchases through any channel. For online payments, the checkout is one-click, and for in-store, express payments are either through a self-checkout or through verbal approval with a sales assistant.

Use cases of the system according to certain embodiments:
Use case 1: The customer enters a store, purchases goods, and pays with his/her standard plastic credit/debit card. The system of the invention captures the customer's details and payment method details. After a period of time, for example a week, the same customer logs into the store's website and purchases items. During checkout, the system of the invention shows the customer his/her previous used payment method, ready to be charged (the same payment method which was used the week before, at the store). The customer clicks “Pay” and the payment method is charged automatically, without the customer needing to do any further action. This is available, as the system of the invention may use several identification and matching options to identify the buyer. Identification may be performed by various means including but not limited to some or all of:
   a. Store Royalty Card or membership card (re: member ID);
   b. Email address that the user is entering at the store;
   c. Other “ID” technology the store uses such as Wi-Fi/chip identifications;
   d. Mobile Device (NFC or Bluetooth);
   e. Mobile phone number.
Use case 2: The e-commerce user enters the store's website from his desktop PC at home. He purchases items and uses his standard credit/debit card to pay for the items, by providing the card's details with the store's online checkout form. The system of the invention typically captures the customer's details and payment method details. After a period of time, for example a week, the same customer goes to the physical store and purchases items. At checkout the sales assistant identifies (by any or all of technological identification means, manual identification means, and self-identification means), the customer and his stored payment method in the system of the invention. The customer approves this payment method (for example, verbally) to complete his checkout. The system of the invention typically IDs the buyer by his details provided on the website (which may be his email, phone number and credit card matching). This can be done when the buyer goes to the store cashier and provides, for example, one of the following means/details: a. His credit card; b. Membership card that has his details on it (email, phone); c. Phone number; d. Other store identification services (mobile device via NFC or Bluetooth).

Generally, there exist solutions that enable merchants to store their customer's payment methods, which are available online. In contrast, certain embodiments of the present invention allow retailers to store and use payment methods across every channel, including but not limited to online/web/mobile/TV/physical stores.

The system is typically configured and operable to allow capturing payment methods and customer details on a first channel on which they occur, and have this data readily available for use on a different channel The system is typically configured and operable to provide the ability to connect between the physical world and e-commerce world by providing an engine which connects the physical purchase and payment process and the online purchase and payment process.

Certain embodiments seek to resolve a long felt need, on the part of computerized merchants, for cross-channel functionality, including associating data stored in the course of a first transaction occurring via a first channel, with a second transaction occurring via a second channel, and using that data to facilitate, or enhance, or conduct, the second transaction e.g. by displaying at least one payment method previously employed in at least one previous transaction, for one-click approval by a customer in a current transaction. A particular advantage is that the customer, in the current transaction, only needs to effect a single click, as opposed to having to laboriously enter payment method details (credit card number, validity etc.) anew.

There is thus provided at least the following embodiments:

Embodiment 1. A method for recognizing end-users communicating with a computerized entity serving end-users via a plurality of entity/end-user communication channels, the method comprising: capturing personal particulars for each individual user from among a multiplicity of end-users via a first channel and storing the personal particulars in a corresponding multiplicity of end-user records in an end-user database, thereby to define a first, data capturing session for each of the multiplicity of end-users; and accessing at least one individual end-user's record in the course of a second, data recognizing session, held via a second channel between the individual end-user and the computerized entity subsequent to the first data capturing session therebetween, the accessing including: recognizing the end-user by using a processor for identifying the end-user record from among the multiplicity of end-user records which corresponds to the end user; and performing at least one of reading from and writing to the end-user record, wherein the first and second channels comprise one physical channel and one online channel.

Embodiment 2. A method according to any of the preceding embodiments wherein the personal particulars include payment method particulars and wherein the reading from comprises reading the payment method particulars and presenting the payment method particulars captured via the first channel to the individual end-user via the second channel

Embodiment 3. A method according to any of the preceding embodiments wherein the presenting comprises providing a one-click user interface element enabling the individual end-user to approve a transaction with the computerized entity based on the payment method particulars read from the individual end-user's record, thereby to define a one-click user experience for end-users communicating with the computerized entity via the second channel, by virtue of payment details previously provided by the end-users via the first channel.

Embodiment 4. A computer-implemented system for recognizing end-users communicating with a computerized entity serving end-users via a plurality of entity/end-user communication channels, the system comprising: a data capturing module operative for capturing personal particulars for each individual user from among a multiplicity of end-users via a first channel and storing the personal particulars in a corresponding multiplicity of end-user records in an end-user database, thereby to define a first, data capturing session for each of the multiplicity of end-users; and a data accessing module operative for accessing at least one individual end-user's record in the course of a second, data recognizing session, held via a channel between the individual end-user and the computerized entity subsequent to the first data capturing session therebetween, the accessing including: recognizing the end-user by identifying the end-user record from among the multiplicity of end-user records which corresponds to the end user; and performing at least one of reading from and writing to the end-user record, wherein the first and second channels comprise one physical channel and one online channel.

Embodiment 5. A system according to any of the preceding embodiments providing omni-channel functionality to at least one computerized entity comprising a merchant which employs a plurality of channels, wherein at least one of the modules resides within a server which is defined by the merchant for external purposes as an additional acquirer and then provides omni-channel functionality to the merchant.

Embodiment 6. A system according to any of the preceding embodiments and also comprising a relational database in data communication with the server and storing transaction data, payment data and user-ID data captured by the data capturing module.

Embodiment 7. A system according to any of the preceding embodiments wherein data pertaining to merchant M is stored in a database encrypted by at least one merchant-specific key, and wherein at least a portion of the key is provided, only on certain occasions, by merchant M,d and is not retained between the occasions by the database.

Embodiment 8. A system according to any of the preceding embodiments wherein at least one merchant comprises a plurality of physical stores in a corresponding plurality of physical locations, all communicating with a server.

Embodiment 9. A system according to any of the preceding embodiments wherein at least one merchant comprises a smart store employing mobile location analytics.

Embodiment 10. A system according to any of the preceding embodiments wherein the at least one computerized merchant comprises a population of computerized merchants and wherein the server provides omni-channel functionality to all of the merchants in the population once each of the merchants in the population has changed its configuration to indicate that the server is an acquirer.

Embodiment 11. A system according to any of the preceding embodiments wherein at least one merchant lacks PHI-level encryption functionality hence cannot store payment method information and wherein the server provides PHI-level encryption, thereby to enable the server to provide omni-channel functionality even to the merchant which lacks PHI-level encryption.

Embodiment 12. A system according to any of the preceding embodiments wherein the channels include at least one physical channel employing legacy point of sale devices.

Embodiment 13. A system according to any of the preceding embodiments wherein the omni-channel functionality comprises using data collected from a first merchant-user transaction via a first channel in the course of a second merchant-user transaction via a second channel.

Embodiment 14. A system according to any of the preceding embodiments wherein at least one of the first and second channels are selected from among: website, physical store, mobile app.

Embodiment 15. A computer program product, comprising a non-transitory tangible computer readable medium having computer readable program code embodied therein, the computer readable program code adapted to be executed to implement a method for recognizing end-users communicating with a computerized entity serving end-users via a plurality of entity/end-user communication channels, the method comprising: capturing personal particulars for each individual user from among a multiplicity of end-users via a first channel and storing the personal particulars in a corresponding multiplicity of end-user records in an end-user database, thereby to define a first, data capturing session for each of the multiplicity of end-users; and accessing at least one individual end-user's record in the course of a second, data recognizing session, held via a second channel between the individual end-user and the computerized entity subsequent to the first data capturing session therebetween, the accessing including: recognizing the end-user by identifying the end-user record from among the multiplicity of end-user records which corresponds to the end user; and performing at least one of reading from and writing to the end-user record, wherein the first and second channels comprise one physical channel and one online channel.

An example flow from a merchant to an Acquirer is based on conventional standard protocols which typically employ Internet as a communication channel (used in a different sense relative to distribution channels defined herein) between a merchant POS and the Acquirer. These protocols are defined between the physical card reader terminal e.g. as manufactured by Verifone or Ingenico at the POS, on the one hand, and the Acquirer or gateway thereto on the other hand. Also employed, typically, are conventional card swipe/EMV/Acquirer protocols. Typically, the Merchant-Acquirer flow comprises the following: POS→sends amount and details to physical card reader terminal→payment Gateway—(card details and transaction details)→Selected Acquirer. It is appreciated that some or all of the cross-channel functionality shown and described herein may, for example:
a. Replace the gateway.
b. Hook onto legacy gateway used by a merchant and retrieve relevant details therefrom
c. Hook to Acquirer to retrieve details therefrom; and/or
d. Replace the card reader terminal with custom configured terminal with cross-channel functionality shown and described herein.

The server is typically operative to access a relational database including related tables each storing data as a multiplicity of records or rows each having fields corresponding to table columns. The tables are related because a primary key in at least one table serves as a foreign key in at least one other table. Optionally, the data (fields, columns) stored for an individual transaction includes an indication of the channel via which the transaction occurs.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer -usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to steps of flowcharts, may be performed by at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and /or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein e.g. by providing one or more modules in the processor/s to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

FIG. 1 is an example of a generally self-explanatory cross-channel system according to certain embodiments such as those described in detail herein.

FIGS. 2a-2c, taken together, form a generally self-explanatory swim-line diagram of methods provided according to certain embodiments.

FIG. 3 is a simplified flowchart illustration of a method provided according to certain embodiments; some or all of the operations illustrated in FIGS. 2-3 may be provided, suitably ordered e.g. as shown.

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Any method described herein is intended to include within the scope of the embodiments of the present invention also any software or computer program performing some or all of the method's steps, including a mobile application, platform or operating system e.g. as stored in a medium, as well as combining the computer program with a hardware device to perform some or all of the steps of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

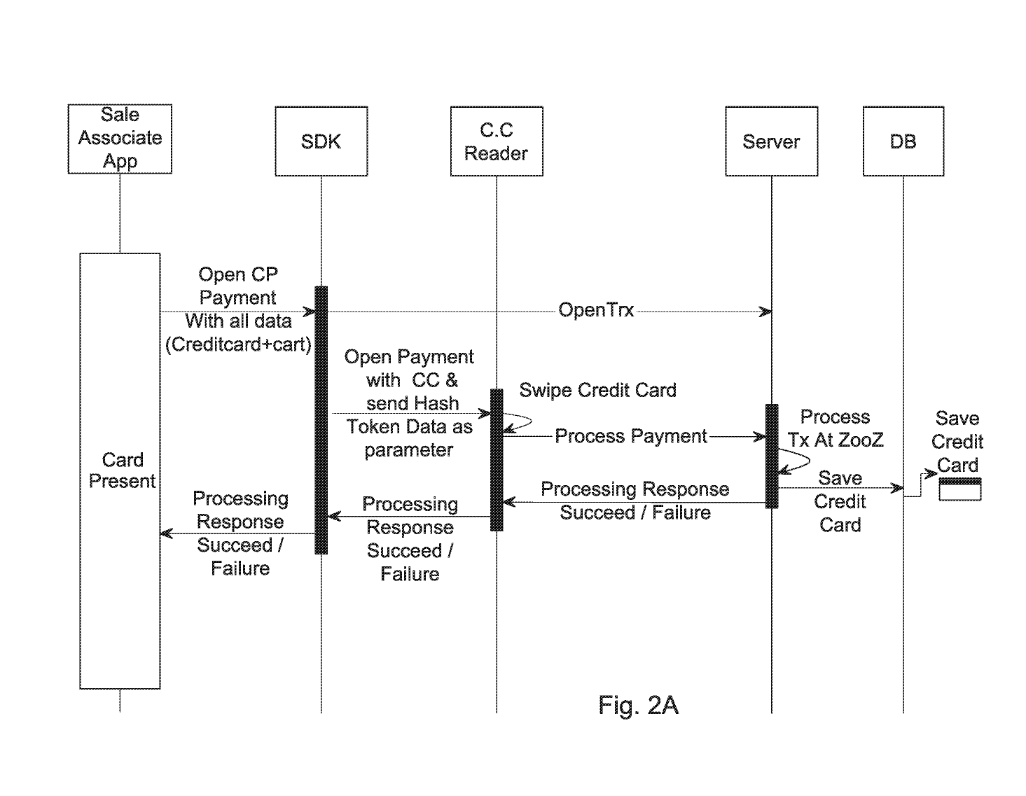

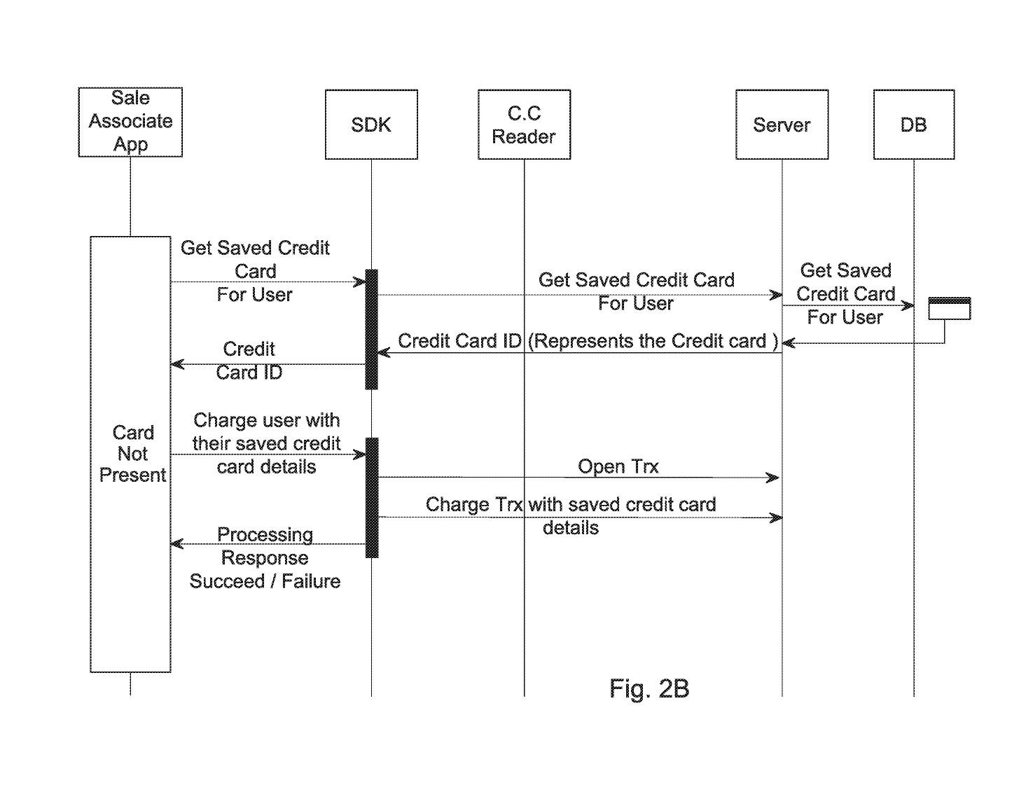

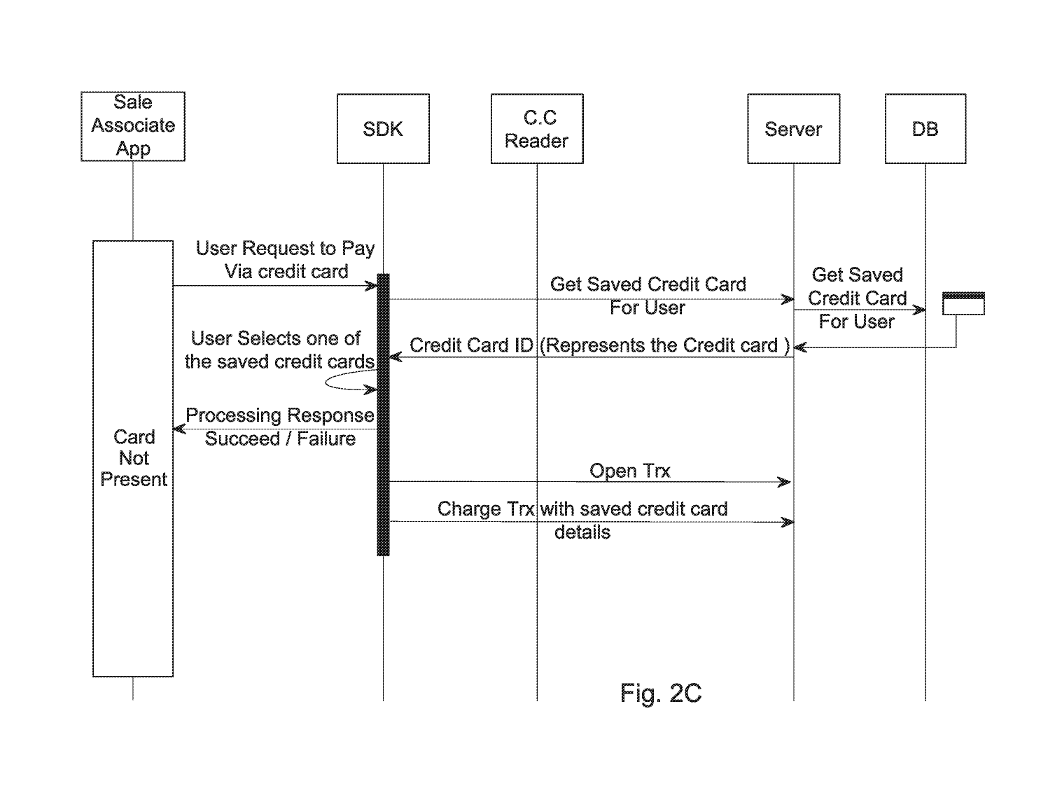

The following terms may be construed either in accordance with any definition thereof appearing in the prior art literature or in accordance with the specification, or as follows:
Acquirer or Merchant service provider: A s/w platform providing, say, payment processing functionality for transactions. Example acquirers are run by PayVision and Adyen. The acquirer may comprise a provider of financial services to merchants e.g. by enabling merchants to accept electronic payment from a customer for a transaction through a secure e.g. encrypted channel, whether face-to-face at merchant or customer premises, on the telephone, or over the Internet, by e.g. TransFirst, National BankCard, Merchant One, Cayan, First Data, Citi or Bank of America. Inter alia, an Acquirer receives transaction data from individual POSs it serves and, typically, using online transaction processing, or OLTP, sends back a message to the relevant POS, authorizing (or not) the transaction in question. The Acquirer has an outgoing interface with the POS's it serves, which may be based on several protocols, e.g. a standard HTTP protocol. Acquirer functionalities typically include all of the following payments functionalities: Authorization calls, Capture Calls, Voids, Refunds, Credits, and tokenization.
API: a set of routines, protocols, and tools which may facilitate programming to enable otherwise distinct applications to share data, thereby to integrate the applications' respective functionalities. An API may include a library having specifications for any or all of routines, data structures, object classes, and variables, thereby to provide description of the behavior of function calls and function prototypes. The application-programming interface (API) may comprise a software-to-software interface defining how s/w applications communicate in the background. Typically, a first software application communicates with a remote application over the Internet using API calls between the applications which are managed using protocols such as but not limited to XML.
Channel (in the sense of a distribution channel): physical or electronic interface via which a merchant interacts with a customer and especially via which a customer effects a purchase, such as website/online, mobile app, TV, or physical store (brick-and-mortar). Points of transactions (unattended, multi-lane, in-store and outdoor, mobile) may also be considered distribution channels.
CP: “Card present” (abbreviation appearing in FIGS. 2a-2c)
Data security standard: A standard like PHI-DSS which is required to be maintained by any databases storing credit card information.
   Logical ID; data e.g. an alphanumeric string used to differentiate one customer from another. For example, each customer may be identified by the MAC address of his or her mobile device or by biometric data unique to that customer, such as a fingerprint. Each fingerprint or face stored may be associated with a unique serial number which may then serve as the logical ID.
Payment Method: e.g. CreditCard, eWallet like PayPal, AliPay, etc. In all of these there is a unique payment identifier, such as a credit card number, or, for PayPal and AliPay, the user's email.
POS: point of sale or service; a checkout device which may be cloud-based, with instant centralization of data, typically accessed directly from the Internet, using an Internet browser. Alternatively data, e.g. re sales and inventory, may be stored in a local rather than remote server. A cloud-based POS system may be bundled with locally implemented checkout software functionalities considered crucial, and which are useful if the Internet connection temporarily fails. A retail point of sale device may include a cash register including some or all of a computer, monitor, cash drawer, receipt printer, customer display, barcode scanner, debit/credit card reader (also termed herein a “card swiper”, and integrated credit card processing system. The POS system software may perform some or all of the following functions: sales, returns, exchanges, layaways, gift cards, gift registries, customer loyalty programs, promotions, discounts. POS software may support multiple payment types (methods). The POS may include a “Back-office” computer typically handling one or more of inventory control, purchasing, receiving and transferring of products to and from other locations. The POS device may store sales and/or customer information for enabling customer returns, reporting purposes, sales trends and for analysis. At least one interface may feed suitable data to external applications and processors. POS devices may include Mobile POS (mPOS) terminals operative for allowing POS transactions to proceed via mobile phones and tablets e.g. iPads. The POS need not include a point of sale terminal, and may instead be as simple as a mobile card reader attached to an iPhone or iPad.

The POS or POS terminal or credit card terminal or payment terminal may be in data communication with software functionality which is pre-programmed, individually for each POS, to provide data communication between the POS and the servers of one or more acquirers. An SDK may be provided for providing communication between the point of sale and a remote acquirer. Each POS typically has a direct telephone or Internet line to a single acquirer (a server and associated database serving many POS's).
“Self User Checkout” (e.g. as in FIGS. 2a-2c): User pays with his own credentials on store POS, user uses his own mobile device, user uses his PC to check out.
Smart store: store which receives signals from connected mobile devices in or near them. Each mobile device with Wi-Fi or Bluetooth turned on, broadcasts a “MAC address”, unique to that device, which is captured by Wi-Fi or Bluetooth sensors. The MAC address may be stored (after hashing, to ensure depersonalization) for use as customer tracking data. Then, location analytics software generates pre-programmed actionable data e.g. by aggregating MAC addresses detected at a given time, determining trajectories, and so on. The actionable data may be accessed via online dashboards provided to store employees.

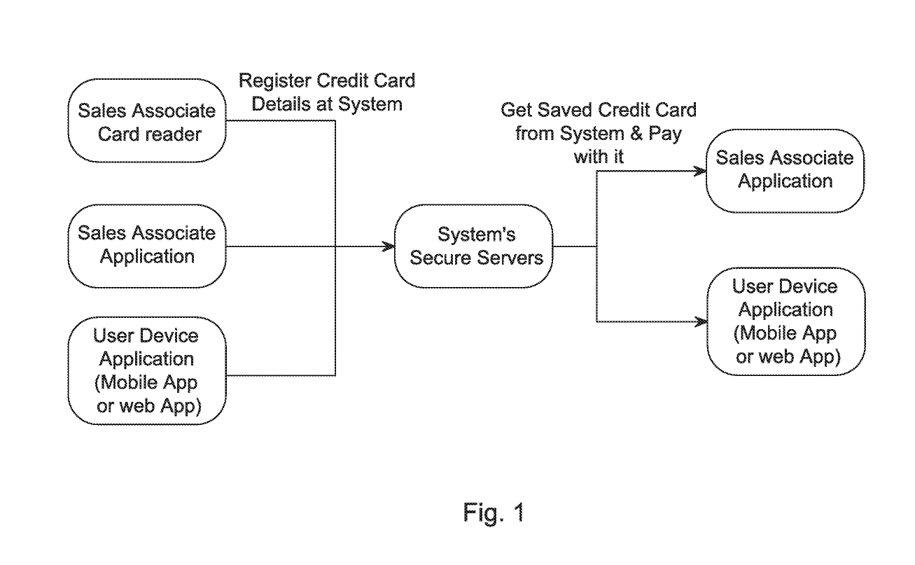

FIG. 1 is an example of a generally self-explanatory cross-channel system according to certain embodiments such as those described in detail herein. FIGS. 2a-2c, taken together, form a generally self-explanatory swim-line diagram of methods provided according to certain embodiments.

The system herein may, according to certain embodiments include some or all of:
a. User—mobile app. May include PC, Keyboard, Mouse, Mobile application from merchant on the store. The mobile phone app may be used to identify the user in the store or at home; the user uses his PC to connect to the merchant's website
b. Merchant Store—WIFI/Bluetooth/NFC equipment, POS Register, credit card reader
c. Sales Associate Device aka “payment device” which may comprise a mobile device (phone or tablet) with card reader.
d. Merchant Website
e. Server aka platform with cross-channel functionality; and associated cross-channel database.
f. Acquirer—remote processor communicating with server e
g. SDK (Software Development Kit) may be installed on the sales associate or the Store POS device and may be operative to fetch relevant data from the sales associate device and send that data to the server/platform.
h. API.

The server facilitate process two types of merchant-customer encounters (potential or actual transactions; note that not every encounter necessarily results in a transaction e.g. if the customer decides not to purchase). The two types of encounters are those in which data is obtained and stored, and encounters in which data is retrieved; some encounters may fall in both categories if data is both obtained/stored and retrieved, in a single encounter. In the former, “obtain details” type of encounter, which may proceed via any suitable channel, customer uses a payment method and her or his details (at least one of store information, user information and payment information) are captured by the server in a manner which varies inter alia as a function of the channel through which the encounter takes place.

In the latter, “retrieve/match details” type of encounter, the customer presents details (at least one of store information, user information and payment information) in a manner which varies inter alia as a function of the channel through which the encounter takes place. Then, the server attempts to match the customer to one of the known customers whose particulars are stored in the database. If this is accomplished, the system may show the customer at least one payment method previously used by her or him, ready to be charged and/or may otherwise utilize stored data about the customer e.g. to generate and present to “up-sale” or “cross-sale” data based on the customer's history. The payment method may then be re-used automatically without the customer needing to do anything other than click “pay”.

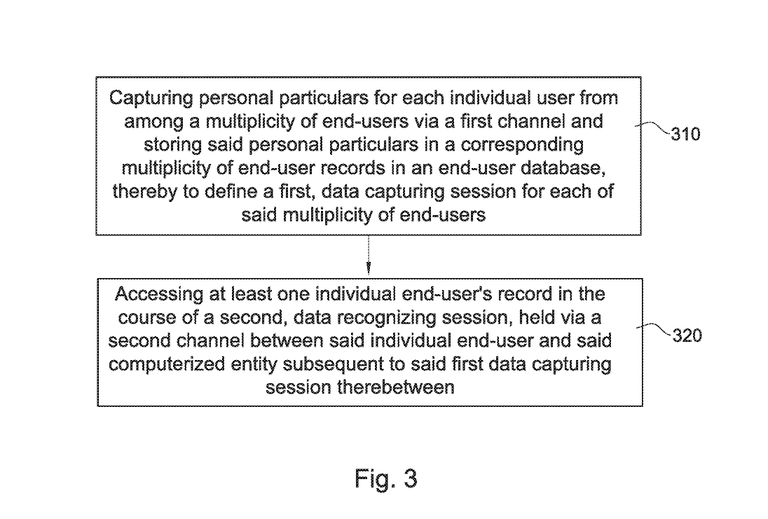

FIG. 3 illustrates a method whereby end-users communicating with a computerized entity serving end-users via a plurality of entity/end-user communication channels, are recognized. The method typically includes:

Operation 310: capturing personal particulars for each individual user from among a multiplicity of end-users via a first channel and storing the personal particulars in a corresponding multiplicity of end-user records in an end-user database, thereby to define a first data capturing session for each of the multiplicity of end-users; and

Operation 320: Accessing at least one individual end-user's record in the course of a second data recognizing session, held via a second channel between the individual end-user and the computerized entity subsequent to the first data capturing session therebetween.

Typically, accessing operation 320 includes:
recognizing the end-user by identifying the end-user record from among the multiplicity of end-user records which corresponds to the end user; and reading from and/or writing to the end-user record.

The (at least) two channels comprise (at least) one physical channel and (at least) one online channel.

Embodiments of the invention are operative in conjunction with payment terminals facilitating merchant-customer transactions where the customer effects payment e.g. via credit card, gift card or cheque, such as Ingenico Smart Terminals or Verifone PAYware® Mobile solutions. The terminals may include devices, preferably Pci compliant, that may attach to, and interface with smartphones and typically portable computers such as tablets, with appropriate terminal application software and encrypted card readers reading magnetic strips and/or smart card chip data. Devices may accept various payment types, such as but not limited to any or all of: EMV chip and PIN, NFC/contactless and magnetic strip payment types. Typically, a human operator (salesperson), on behalf of the merchant, can insert, swipe, or manually enter credit card data. This data is transmitted to a merchant service provider (acquirer) for authorization. Typically, each POS has a direct telephone or Internet line to a single acquirer or gateway (i.e. to a single server and associated database serving many POS's). Eventually, funds are transferred to the merchant.

Terminals may transmit data e.g. card data over a standard telephone line or a wired or wireless Internet connection. Terminal applications may support manual entry of the credit card number. The terminals preferably ensure merchant compliance with PCI DSS requirements. The terminals are typically pre-programmed, individually for each POS, to provide data communication between the POS and the servers of one or more acquirers.

Conventional transactions include some or all of the following conventional operations: Application selection, Initiate application processing, Read application data, Processing restrictions, Offline data authentication, Cardholder verification, Terminal risk management, Terminal action analysis, First card action analysis, Online transaction authorization, Second card action analysis, and Issuer script processing. Conventional protocols such as but not limited to ISO/IEC 7816-3 or ISO/IEC 14443 typically govern transmissions between chip cards and readers.

A suitable standard such as EMV may be used to uniformize interactions between IC cards and IC card processing devices at the physical, electrical, data and application levels, e.g. by uniformizing some or all of: Application Independent ICC to Terminal Interface Requirements, Security and Key Management, Application Specifications, Cardholder, Attendant, and Acquirer Interface Requirements, Common Payment Application Specification, and Card Personalisation.

Conventional protocols may also be employed between a merchant POS'S physical card reader terminal (e.g. Verifone or Ingenico) and, ultimately, the Acquirer. Most protocols are routed, say via Internet (say), to the acquirer not directly, but rather through a “gateway” e.g. payment gateway.

In conventional flows, a POS processor typically sends a transaction amount and other transaction particulars, such as card details, to an integral physical card reader terminal and thence to a Selected Acquirer typically via a payment Gateway. It is appreciated that some or all of the cross-channel functionality shown and described herein may, for example: a. replace the gateway; and/or b. hook onto legacy gateway used by a merchant and retrieve relevant details therefrom; and/or c. hook onto the legacy acquirer to retrieve details therefrom; and/or d. the legacy card reader terminal may be replaced with a custom configured terminal with cross-channel functionality e.g. as shown and described herein.

According to Wikipedia, when a customer orders a product from a payment gateway-enabled merchant, the payment gateway may, in conjunction with other entities, perform (some or all of) the following transaction processing operations, in any suitable order e.g. as presented by Wikipedia, and any or all of these may be modified to accommodate for the cross-channel functionalities shown and described herein:
1. If the order is via a website, the customer's web browser encrypts the information to be sent between the browser and the merchant's webserver e.g. via SSL (Secure Socket Layer) encryption. The payment gateway may allow transaction data to be sent directly from the customer's browser to the gateway, bypassing the merchant's systems, thereby to reduce the merchant's PCI DSS compliance obligations without redirecting the customer away from the website.
2. The merchant then forwards the transaction details to the payment gateway which may comprise another (SSL) encrypted connection to the payment server hosted by the payment gateway.
3. The payment gateway forwards the transaction information to a payment processor used by the merchant's acquiring bank.
4. The payment processor forwards the transaction information to a card association which sometimes also acts as the issuing bank, and directly provides a response of approved or declined to the payment gateway. Otherwise (e.g. if a MasterCard or Visa card was used), the card association typically routes the transaction to the correct card issuing bank.
5. The credit card issuing bank receives the authorization request and credit or debit checks, and then sends a response back to the processor (e.g. via the same process as the request for authorization) with a response code (e.g. authorization request approved/denied). The response code may also be used to define the reason why the transaction failed (such as insufficient funds, or bank link not available). Meanwhile, the credit card issuer holds an authorization associated with that merchant and consumer for the approved amount.
6. The processor forwards the authorization response to the payment gateway which, upon receipt of the response, forwards it on to the website or other interface used to process the payment. There, the response is interpreted as a relevant response, which is then relayed back to the merchant and cardholder. This is known as Authorization (“Auth”).
7. The merchant fulfills the order and the above process is repeated, but this time to “Clear” the authorization by consummating the transaction. Typically, “Clear” is initiated only after the merchant has fulfilled the transaction (e.g. shipped the order). Responsively, the issuing bank ‘clears’ the ‘auth’ (e.g. moves auth-hold to a debit) and prepares for settlement with the merchant acquiring bank.
8. The merchant typically submits all approved authorizations, in a “batch” (e.g. at the end of the day), to an acquiring bank for settlement via the banks processor.
9. The acquiring bank makes the batch settlement request of the credit card issuer. The credit card issuer makes a settlement payment to the acquiring bank (e.g. the next day).
10. The acquiring bank subsequently deposits the total of the approved funds into the merchant's preprogrammed account (e.g. the day after).

Typically, if a user is not identified as having a “Logical” ID, he is treated by the server/platform as a new user/purchase rather than trying to match purchase and payment history to that user. Any suitable scenario may be programmed to occur if not all details presented match the ones stored on the database e.g. if stored and presented phone numbers do not match, but email addresses do match. Typically, to be on the safe side, all defined information must match before the system enables a user to be presented with particulars of a previously used and stored payment method. It is possible, according to certain embodiments, to use a less stringent criterion (a less than perfect match) for assuming a match with, and utilizing, stored user data other than payment method data.

According to certain embodiments, data stored in the database re a particular user may be divided into some or all of the following three categories, each of which may include some or all of the following fields:
Store Info—“Logical” ID.
User Info—fields may include may include some or all of: Name, Address, Email, Phone
Payment Info—fields may include may include some or all of: Card Number, ExpDate, Billing ZipCode

Typically, only when all fields within all three categories match, the system server concludes that the current user matches the stored user particulars, hence it is permissible to present to the current user, his previously used payment methods for his approval. In contrast, in the event of a partial match, the user, whose data partially matches stored data, is treated as a new user e.g. for cross-channel purposes (if the same user logs twice into the website, he would be recognized).

According to certain embodiments, the server/platform sends back to the sales associate both matching info and info that does not match. The sales associate can then ask the user for more ID to try and establish a match, for fraud and risk purposes.

According to certain embodiments, if user details and store details match, but the user's current credit card is not in the database, the server may deem the user to be a recognized one, but may not show that any previous payment methods were used.

Generally, cross-merchant functionality is not provided; however, cross-channel functionality within a single merchant is provided.

To enable credit card numbers to be saved in the database so as to facilitate searching cross-channel for users, by credit card, a suitable Data security standard such as PCI-DSS is typically maintained in the database.

Certain embodiments include some or all of the following advantages, cross-channel: Data Analytics—provides in-depth insights into the transactions and purchases information; “Zero” click checkout at the store, because the sales associate can make the purchase by auto-identifying the customer, and one-click checkout for a customer who has purchased at the store and subsequently logs into the same merchant's website.

At checkout, the sales assistant identifies the customer and his stored payment method by any suitable procedure: technological identification (e.g. of MAC address or biometric data), manual identification e.g. when user keys in his own data, and self-identification e.g. when a sales assistant keys in, say, contents of an identity card presented by the user.

According to certain embodiments, at least some of the data in the database is stored encrypted, using any of the features or embodiments of the Hack-Deterring System For Storing Sensitive Data Records described in U.S. Pat. No. 8,924,711. The features described in U.S. Pat. No. 8,924,711 include any or all of the elements of any or all of the embodiments described therein such as but not limited to: A mobile communication system comprising: a server communicating with mobile devices via a communication network; and a central database which is in data communication with the server and which is operative for storing sensitive data encrypted using at least one device key, at least a portion of which is provided, only on certain occasions, by an individual one of the mobile devices and is not retained between the occasions by the central database, wherein each device encrypts both the device key and sensitive computer data associated with the device and sends them to the server, the server decrypts the received information thereby to yield the sensitive computer data associated with the device and the device key, the server encrypts the sensitive computer data associated with the device with the device key, and the server stores the encrypted data in the database and discards the device key.

An advantage of this is that thereby, a stolen key may be employed only to read data for a single credit card rather than for all credit cards stored in the system.

Applicability of certain embodiments extends to merchants employing mobile card-readers attached, say, to an iPhone or iPad and is not limited to merchants employing point of sale terminals.

Example use cases and scenarios are now described.

Use case 1: User enters a merchant store and would like to buy a shirt.

The user is in a smart or conventional store. A sales associate with a payment device approaches him and tells him that he can pay for the shirt either at the cash register or with him (using the payment device).

Scenario 1: regular store; user wishes to pay with the sales associate. The sales associate asks the user for his name, email and phone number and then for his credit card. The user presents his credit card to the sales associate who swipes the card. All information (user information, payment information) may be collected by the sales associate plus all the purchase details e.g. items, SKUs, Price, Qty and transferred via the platform/server to the database for storage

Scenario 2: smart store; user wishes to pay via the sales associate. The smart store enables the merchant to know who is currently in the store and generates a “Logical” id for that user/customer; typically this occurs if the user has previously registered for this purpose e.g. by downloading and signing up for the merchant's mobile app. Any suitable technology e.g. WIFI network, Bluetooth or even NFC technology and merchant store-user process may be employed to identify the customer e.g. store-installed WIFI/BT/NFC antennas find the users' mobile app and identifies the user using the mobile device on which the app is installed.

The sales associate asks the user for his name, email and phone number, and then for his credit card—in this case the device gets the “Logical” id typically comprising a unique user id generated by the store automatically when the user provides his mobile phone number to the sales associate. The user presents his credit card to the sales associate who swipes the card. All data collected by the sales associate (including the “Logical” ID), plus the purchase details are transferred via the platform/server to the database. The server sends the payment information to a suitable acquirer and typically gets an immediate response as to whether the transaction is approved or declined. The server sends this information back to the sales associate device. If indeed the payment is approved, the user is given his new shirt, and leaves the premises. Subsequently, the same user decides to purchase a tie for the shirt he has already purchased. He goes to the merchant's website, looking for a matching tie for his shirt, and logs onto the website with his user/password.

Typically the merchant's website is previously integrated with the server/platform in a set-up process using the API to integrate with the platform. The data sent via this API typically includes purchase information, payment information and user information, just as though the user had visited the store. Typically, all data which is so fed to the server/platform by the merchant, is stored in the database. If, within the provided data, a “Logical” Id is found to exist (e.g. because the user who logged onto the website is already registered with this merchant), the merchant is then able to send to the platform/server the unique “Logical” ID this merchant has assigned to the user, typically along with the user's name, phone, email) to check if this is a user whose methods of payment (say) are known to the database from previous purchases.

If the server recognizes the “logical” ID, the server returns, to the merchant website, data regarding the user's previous purchases and payment methods. This enables the merchant website to show the user that he just made a purchase of shirt x in the branch located in ‘Amsterdam Ave.’ and/or to generate and present to the user “up-sale” and “cross-sale” data which may help the user to select a suitable tie. The user finds a matching tie, clicks “Checkout” and is presented with payment methods which the database has stored for him, including, but perhaps not limited to, the credit card or eWallet which he used to purchase the shirt.

The website now sends all the user, payment, purchase information (also termed herein store, user, payment data respectively) to the server/platform. The server/platform forwards the data to the relevant acquirer which need not be the same acquirer which processed this user's previous transaction. Once payment has been approved by the acquirer, the server/platform returns the response back to the merchant's website to enable the website to display to the user his transaction confirmation message. Also, the tie is sent to the user.

After a period of three weeks, the same user finds himself back in ‘Amsterdam Ave.’ and enters the merchant's (smart) store once again. He is identified, hence his logical ID is made available to the server/platform. A sales associate now approaches the identified user and offers assistance. The user now wishes to purchase pants. The sales associate searches for his details and sees that this user purchased a shirt and a tie during the last three weeks. The sales associate now knows exactly what the user bought, and can offer him a matching blazer or pants.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present disclosure, inter alia, are electromagnetic signals in accordance with the description herein. These may carry computer-readable instructions for performing any or all of the steps or operations of any of the methods shown and described herein, in any suitable order including simultaneous performance of suitable groups of steps as appropriate; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including at least one processor and/or cooperating input device and/or output device and operative to perform e.g. in software any steps shown and described herein; information storage devices or physical records, such as disks or hard drives, causing at least one computer or other device to be configured so as to carry out any or all of the steps of any of the methods shown and described herein, in any suitable order; at least one program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; at least one processor configured to perform any combination of the described steps or to execute any combination of the described modules; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention, including method steps, which are described in the context of separate embodiments may also be provided in combination in a single embodiment. For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including method steps, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the steps illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A method for recognizing end-users communicating with a computerized entity serving end-users via a plurality of entity/end-user communication channels, the method comprising:
capturing personal particulars for each individual user from among a multiplicity of end-users via a first channel and storing said personal particulars in a corresponding multiplicity of end-user records in an end-user database, thereby to define a first, data capturing session for each of said multiplicity of end-users; and
accessing at least one individual end-user's record in the course of a second, data recognizing session, held via a second channel between said individual end-user and said computerized entity subsequent to said first data capturing session therebetween, said accessing including:
recognizing said end-user by using a processor for identifying the end-user record from among said multiplicity of end-user records which corresponds to said end user; and
performing at least one of reading from and writing to said end-user record,
wherein the first and second channels comprise one physical channel and one online channel.

2. A method according to claim 1 wherein said personal particulars include payment method particulars and wherein said reading from comprises reading said payment method particulars and presenting said payment method particulars captured via said first channel to said individual end-user via said second channel.

3. A method according to claim 2 wherein said presenting comprises providing a one-click user interface element enabling said individual end-user to approve a transaction with said computerized entity based on said payment method particulars read from said individual end-user's record, thereby to define a one-click user experience for end-users communicating with the computerized entity via the second channel, by virtue of payment details previously provided by the end-users via the first channel.

4. A computer-implemented system for recognizing end-users communicating with a computerized entity serving end-users via a plurality of entity/end-user communication channels, the system comprising:
a data capturing module operative for capturing personal particulars for each individual user from among a multiplicity of end-users via a first channel and storing said personal particulars in a corresponding multiplicity of end-user records in an end-user database, thereby to define a first, data capturing session for each of said multiplicity of end-users; and
a data accessing module operative for accessing at least one individual end-user's record in the course of a second, data recognizing session, held via a channel between said individual end-user and said computerized entity subsequent to said first data capturing session therebetween, said accessing including:
recognizing said end-user by identifying the end-user record from among said multiplicity of end-user records which corresponds to said end user; and
performing at least one of reading from and writing to said end-user record, wherein the first and second channels comprise one physical channel and one online channel.

5. A system according to claim 4 providing omni-channel functionality to at least one computerized entity comprising a merchant which employs a plurality of channels, wherein at least one of said modules resides within a server which is defined by the merchant for external purposes as an additional acquirer and then provides omni-channel functionality to the merchant

6. A system according to claim 4 and also comprising a relational database in data communication with the server and storing transaction data, payment data and user-ID data captured by said data capturing module.

7. A system according to claim 5 wherein data pertaining to merchant M is stored in a database encrypted by at least one merchant-specific key, and wherein at least a portion of said key is provided, only on certain occasions, by merchant M,d and is not retained between said occasions by the database.

8. A system according to claim 1 wherein at least one merchant comprises a plurality of physical stores in a corresponding plurality of physical locations, all communicating with a server.

9. A system according to claim 5 wherein at least one merchant comprises a smart store employing mobile location analytics.

10. A system according to claim 5 wherein said at least one computerized merchant comprises a population of computerized merchants and wherein said server provides omni-channel functionality to all of the merchants in said population once each of the merchants in said population has changed its configuration to indicate that said server is an acquirer.

11. A system according to claim 5 wherein at least one merchant lacks PCI-level encryption functionality hence cannot store payment method information and wherein said server provides PCI-level encryption, thereby to enable the server to provide omni-channel functionality even to said merchant which lacks PCI-level encryption.

12. A system according to claim 5 wherein said channels include at least one physical channel employing legacy point of sale devices.

13. A system according to claim 5 wherein said omni-channel functionality comprises using data collected from a first merchant-user transaction via a first channel in the course of a second merchant-user transaction via a second channel.

14. A system according to claim 1 wherein said physical channel is selected from among: in-store (physical store), self-checkout.

15. A computer program product, comprising a non-transitory tangible computer readable medium having computer readable program code embodied therein, said computer readable program code adapted to be executed to implement a method for recognizing end-users communicating with a computerized entity serving end-users via a plurality of entity/end-user communication channels, the method comprising:
capturing personal particulars for each individual user from among a multiplicity of end-users via a first channel and storing said personal particulars in a corresponding multiplicity of end-user records in an end-user database, thereby to define a first, data capturing session for each of said multiplicity of end-users; and
accessing at least one individual end-user's record in the course of a second, data recognizing session, held via a second channel between said individual end-user and said computerized entity subsequent to said first data capturing session therebetween, said accessing including:
recognizing said end-user by identifying the end-user record from among said multiplicity of end-user records which corresponds to said end user; and
performing at least one of reading from and writing to said end-user record, wherein the first and second channels comprise one physical channel and one online channel.

16. A system according to claim 1 wherein said online channel is selected from among:
smartphone, desktop, mobile phone/app, tablet, website, on-line check-out form and combinations thereof e.g. on-line check-out form on merchant website, accessed via desktop, mobile phone, smartphone, or tablet.
